(19) United States
(12) Patent Application Publication
(10) Pub. No.: US 2006/0285336 A1
(43) Pub. Date: Dec. 21, 2006

(54) High intensity back light assembly

(76) Inventor: Harry Davies, Brookfield, CT (US)

Correspondence Address: WEINGRAM & ASSOCIATES P.C., P.O. BOX 927, MAYWOOD, NJ, 07607, US

(21) Appl. No.: 11/256,663

(22) Filed: Oct. 21, 2005

Related U.S. Application Data
(60) Provisional application No. 60/621,244, filed on Oct. 22, 2004.

(51) Int. Cl. F21V 29/00; B60Q 1/06

(52) U.S. Cl. 362/373; 362/294

(57) ABSTRACT

A high intensity back light assembly or high brighting LCD flat panel display which incorporates a precision machined light box having machined surfaces on the front to receive thin fluorescent light tubes and efficiently reflect the light from these tubes to the back of the liquid crystal display. The back of the light box contains troughs which are machined into the metal and which coact with the main circuit board to form a manifold or plenum for conducting cooling air long and around the back of the light box by means of fans mounted on and which discharge through passages in the main circuit board. Air is exhausted from the plenum formed by the coaction of the main circuit board and the troughs in the back of the light box through other passages in the main circuit board to cool the other circuits mounted on the circuit board associated with the back light assembly.

### FIELD OF THE INVENTION

This invention relates to electronic or video displays and more particularly to displays that are illuminated by very thin fluorescent tubes.

### BACKGROUND

Flat panel displays are illuminated by means of very thin and fragile fluorescent tubes for general purposes such as computer screens. The number of tubes is usually between 1 and 4 and sometimes 6. The flat paneled displays usually have a liquid crystal display disposed in front of the array of fluorescent tubes. Depending upon the liquid crystal display arrays, more or less light will be transmitted through the panel for viewing. But for many applications, especially for those in which the display panel is exposed to direct sunlight, such as in the aviation or in military applications, the light output from the fluorescent tubes is not enough to over power the high intensity of direct sunlight or direct artificial lighting.

In order to provide sufficient light, many displays “high bright” the display panels. They take the existing 2 or 4 tube assemblies out and put in arrays of tubes of 24 or more. In order to position these 24 tubes into the display, they have to be physically placed very carefully and then you have to attach wires to each of these tubes. These wires have to go through a module known as an inverter. The inverter develops a high voltage necessary to ignite the tube. The problem with the present high bright assemblies is that they have a multitude of wires coming off the tubes. Additionally, the tubes which are placed in a light box are positioned in front of white reflectors that are typically glued in place to the light box to push as much light towards the liquid crystal display as possible. Typically, the reflector material is glued down and is prone to shifting because of heat and warpage. The high bright displays are subject to strenuous environmental conditions which tend to cause problems with the numerous wires coming off the tubes and other wires connecting the various circuits. The fragility of the wires and the large buildup associated with the high bright displays causes problems with durability and reliability of these displays.

The present invention avoids the complex wiring problems and the heat buildup associated with the high bright or high intensity back light assemblies. The light box that holds the tubes is machined from a solid slab of aluminum. The tubes drop in, the tube wires are bent on the tubes and they drop into the holes in the light box. The tubes are spaced from the light box by an insulating spacer, preferably ceramic, which has a hole for the wires to pass through. The spacers regulate the height of the tubes in the light box. Additionally, the front surface of the light box is painted with a reflecting paint so that there is no possibility of any glue on reflective material to melt or shift or degrade or peel away.

Another important feature of the high intensity back light assembly of the present invention is the back surface of the light box which is machined to provide a manifold system in combination with the circuit board for the wiring associated with the fluorescent tubes. Connectors are soldered to be back of the circuit board and the inverters are then plugged into place on the board. This eliminates manual wiring. It also eliminates the characteristics or problems that can arise because of wire placement. Assembly of the entire unit is much more rapid and accurate.

The back of the light box has channels or troughs which promote airflow from fans mounted on the back of the main circuit board that discharge through passages in the circuit board. The fans blow cooling air to dissipate heat produced from the circuitry and the fluorescent tubes. The cooling air exits through other holes in the circuit board. The inverters which drive the high voltage tubes totally plug into the back of the circuit board completely eliminating the labor and the potential risk of damage to the tubes and eases the assembly process.

### OBJECTS AND SUMMARY OF THE INVENTION

The present invention comprises a high intensity back light assembly or high brighting LCD flat panel display which incorporates a precision machined light box having machined surfaces on the front to receive thin fluorescent light tubes and efficiently reflect the light from these tubes to the back of the liquid crystal display. The back of the light box contains troughs which are machined into the metal and which coact with the main circuit board to form a manifold or plenum for conducting cooling air along and around the back of the light box by means of fans mounted on and which discharge through passages in the main circuit board. Air is exhausted from the plenum formed by the coaction of the main circuit board and the troughs in the back of the light box through other passages in the main circuit board to cool the other circuits mounted on the circuit board associated with the back light assembly.

Accordingly, it is an object of the present invention to provide a high intensity back light assembly which is relatively durable.

It is another object of the present invention to provide a high intensity back light assembly which is highly efficient with respect to light emissions.

It is another object of the present invention to provide a high intensity back light assembly which reduces the amount of wiring necessary during fabrication.

It is another object of the present invention to provide a high intensity back light assembly which reduces the amount of heat which is accumulated by operation of the apparatus.

It is another object of the present invention to provide a high intensity back light assembly which minimizes the assembly procedures necessary for fabricating the device.

It is another object of the present invention to provide a high intensity back light assembly which includes a cooling system formed by the light box and the main circuit board to cool the light box and to cause the fluorescent bulbs to run at optimum performance.

It is another object of the present invention to provide a high intensity back light assembly which is relatively easy to manufacture.

It is another object of the present invention to provide a high intensity back light assembly which is reliable in operation.

It is another object of the present invention to provide a high intensity back light assembly which can be easily repaired.

### BRIEF DESCRIPTION OF THE DRAWINGS

For a more complete understanding of the present invention reference may be had to the following drawing taken in connection with the description of the preferred embodiments, of which:

FIG. 1 is a schematic view showing the components of a high intensity back light assembly built in accordance with the teachings of the present invention.

FIG. 2 is a more detailed, but still schematic view, showing the major elements of the high intensity back light assembly from the rear.

FIG. 3 is a schematic and partially exploded view of the light box assembly for the high intensity back light assembly.

FIG. 4 is a schematic view showing the relationship of the fluorescent bulbs, the light box, and the main circuit board.

FIG. 5 is a perspective schematic view showing the structure of the front of the light box.

FIG. 6 is a schematic view showing from the side showing the relationship of the main circuit board, the fluorescent bulbs, the light box and the cooling fan.

FIG. 7 is a schematic view of a partial cross section showing the mounting of the fan on the circuit board to the light box and the output of the fan discharging into the plenum.

FIG. 8 is a schematic view showing the troughs machined in the back of the light box FIG. 9 is a schematic view showing the various passages formed in the main circuit board.

### DETAILED DESCRIPTION

Liquid Crystal Display's or LCD's, commonly called flat panel monitors are used everywhere today and are very popular and reliable. They operate by illuminating the rear of the LCD with white light. An image is generated by turning on various red, green or blue and white cells or pixels to allow various colors and patterns to be presented on the front surface of the screen. The overall brightness is usually determined by the total amount of white light behind the LCD. Keeping in mind that about 90° of the rear light is lost even when all the pixels are turned on. This means that for many applications, the displayed image is not bright enough.

Such special applications include medical, military and any other applications where strong sunlight and artificial light would “wash out” the image.

Many companies “High Bright” LCDs by adding more fluorescent tubes to increase brightness. Typical LCDs obtain between 1 and 4 CCFL (Colr Cathode Fluorescent Light) tubes. In a typical hi-bright application, for example a 17″ LCD would require the addition of a total 24-28 CCFL tubes for hi-brite purposes.

Generally many companies hi-brite by placing the tubes either with adhesive or two thin circuit boards in a sheet metal “light box” and attach wires (high voltage) to the special power supply that powers the CCFL tubes. The inside of the light box usually has a white sheet of plastic glued behind the tubes to reflect as much light towards the LCD as possible.

Sometimes the adhesive will release due to the high heat of operation and shift causing various shading or other visual defects on the LCD. Another problem is high heat build up and high labor costs and various tolerances due to the large amount of hand labor.

Our new design uses a solid aluminum alloy blank which is machined with round semi-troughs to reflect more of the light to the front of the LCD. The machinery surface is painted to eliminate any chance of the reflector material from shifting. The CCFL wires are bent at 90° and dropped into the front of the light box via high voltage ceramic insulators and any other spacers necessary to guarantee proper alignment.

The CCFL wires are then soldered to a circuit board directly behind the light box. The rear of the light box also has several unique features that are a benefit to hi-brite LCD's.

Machines channels are placed into the rear of the alloy light box.

When the circuit board is placed on the light box rear, fans are attached, so that when thermostatically operated, the fans will force cooling air through the light box rear and out through holes in the circuit board, carrying out damaging heat.

In addition to the fan cooling feature, which will reduce temperatures by over 25° F., the circuit boards completely eliminates high voltage wires to the CCFL tubes.

For proper CCFL operation, a small circuit board called an inverter is utilized. Once the correct inverter(s) is selected, usually high voltage wires are connected to the inverter and routed (connected to the CCFL tubes). The wire length and position can affect tube performance, and if not placed and positioned properly, can lead to shorts of burned wires if the insulation is violated.

The circuit board design of the present invention incorporates connectors placed directly on the circuit board and appropriate mounting hardware to allow the inverter(s) to be mounted directly to the LCD circuit board. This completely eliminates any high voltage wires and the display problems. It also eliminates much lost time for manual labor to cut and install connectors to high voltage wires.

The inverters are mounted upside down (component side down) to allow cooling air exiting the holes in the printed circuit board to wash over the hot components of the inverters, helping to cool them. Any electronic device that runs cooler will have a longer life expectancy.

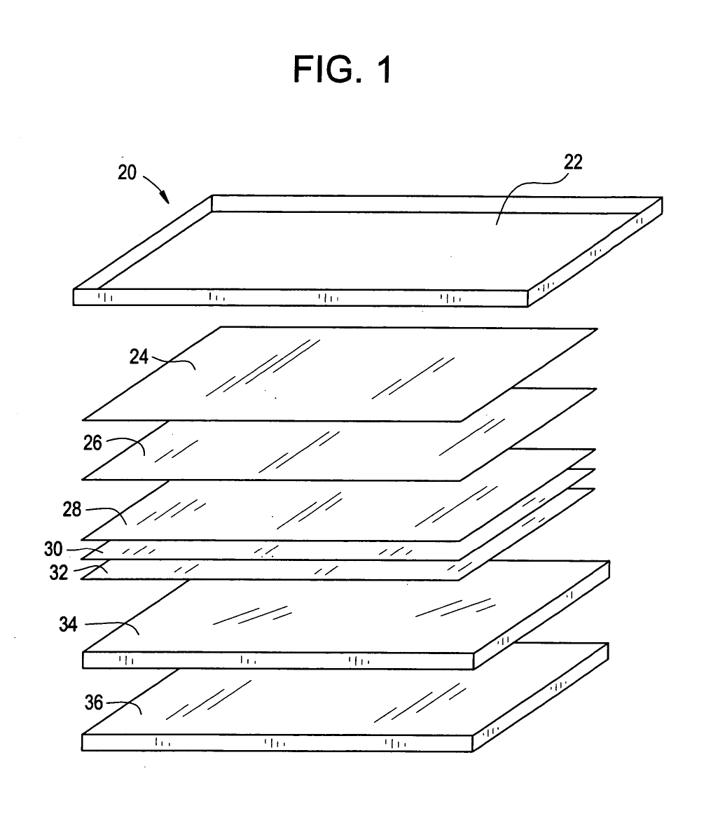

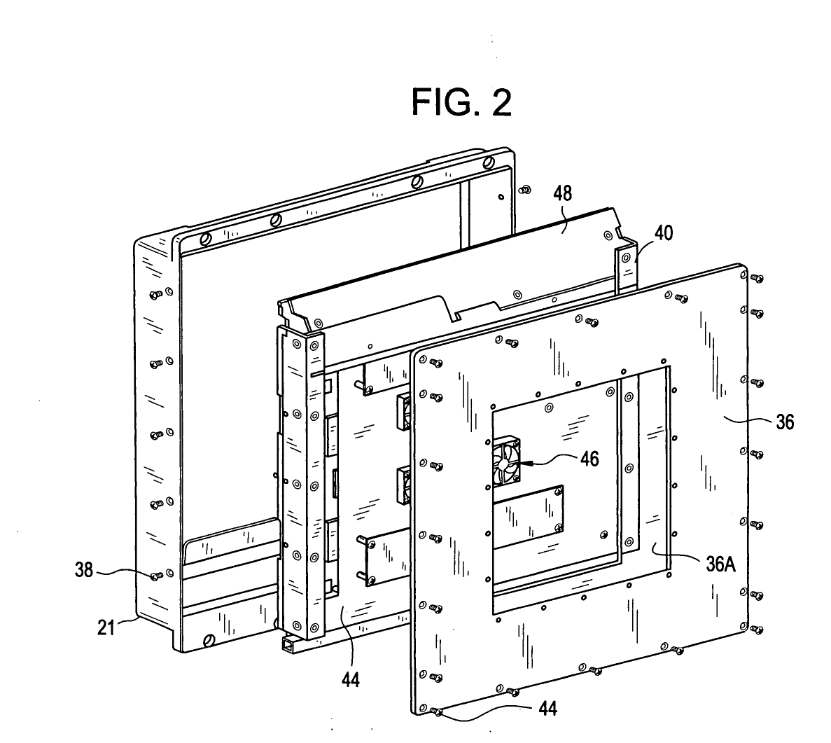

Referring to the Figs., FIGS. 1 and 2 show schematic views of the major components that are used in fabricating the present back light assembly. The back light assembly 20 has a frame 22 into which a viewing glass 24 is positioned. A liquid crystal display 26 and front, mid and rear films 28,30,32 for the liquid crystal display operation which are placed behind the liquid crystal display are positioned before a light box assembly 34 and then there is a back cover 36.

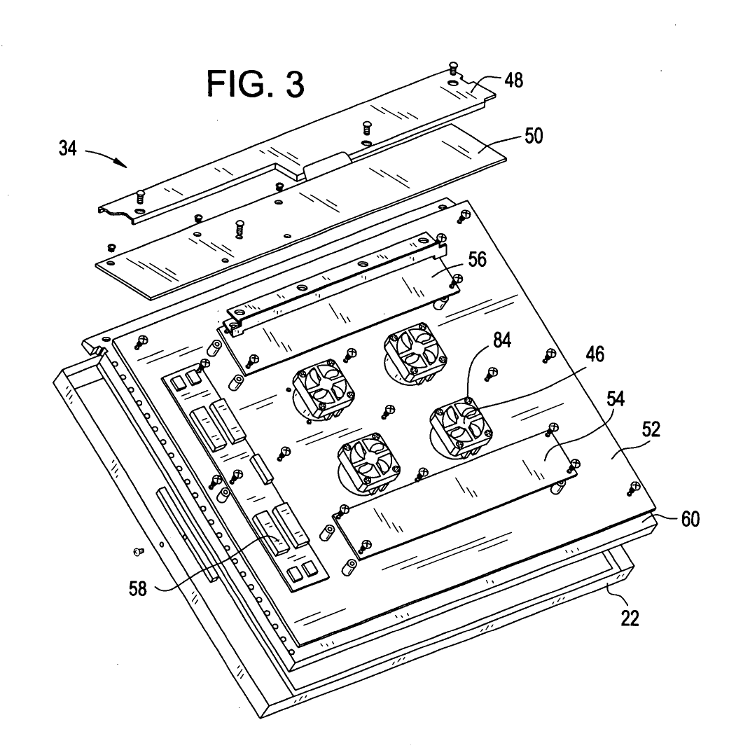

As seen in FIGS. 2 and 3, the back cover has an opening 36A so that the display can be communicated to the equipment with which it is associated. The light box assembly 34 which includes the LCD has a circuit board shield 48 covering an LCD circuit board 50 on top and a main circuit board 52 which coacts with the back of the light box to form a cooling manifold.

The present invention is duplex in nature in that it retains the standard four fluorescent tubes that are usually used for flat screen liquid crystal displays, and incorporates an additional 24 tubes which are used for the high intensity operation of the display.

The normal tubes can be used in instances where the high intensity tubes are not needed such as, for example, at night time or in indoor locations where there is not sufficient glare to compromise the performance of the display.

As shown in FIG. 3, the light box assembly has a frame 22 for the LCD 26 and light management system, a light box 60 and the main circuit board 44. Mounted on the back of the main circuit board 44 is the original inverter for the standard lights. Four cooling fans 46 A,B,C and D and two inverters 54 and 56 are used for servicing the additional 24 fluorescent bulbs 66. There is also a circuit board 50 for the liquid crystal display and a shield 48 for the circuit board 50.

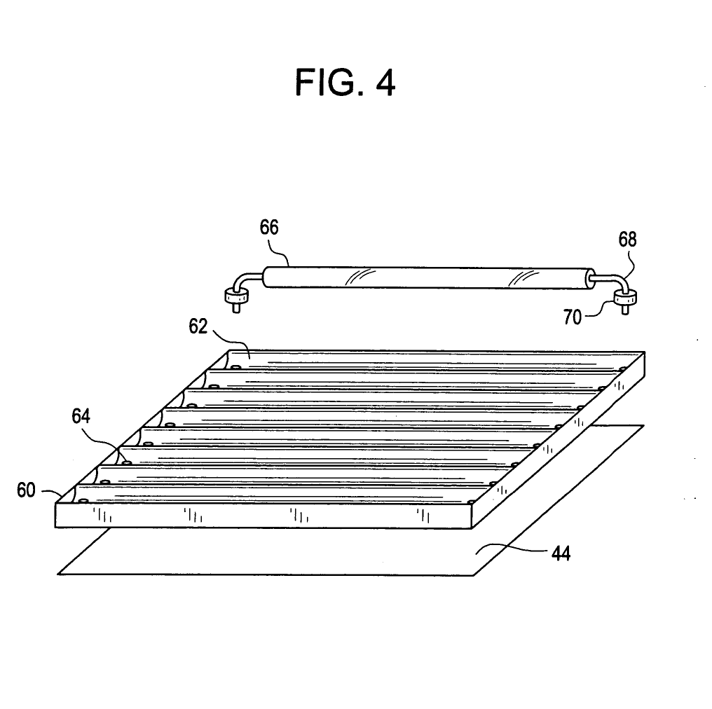

As seen in FIG. 4, the additional bulbs 66 used for high intensity operations are mounted in individual scalloped receptacles 62 on the front of the light box 60. Each of the bulbs 66 has an electric wire 68 extending from each end which passes through an insulating spacer 70 which is made of ceramic or any other material that can serve the purpose, but which spacer positions the fluorescent bulb in the scalloped surface 62 on the front of the light box 60. At each end of the scalloped surface there is a passage 64 for the electric wire to pass through for connection to the main printed circuit board 44.

The scallop surfaces 62 tend to act as natural reflectors which reflect the light from the fluorescent bulb 66 to the back of the liquid crystal display 26. They are painted with a highly reflective material to enhance the efficiency of the light produced by the apparatus.

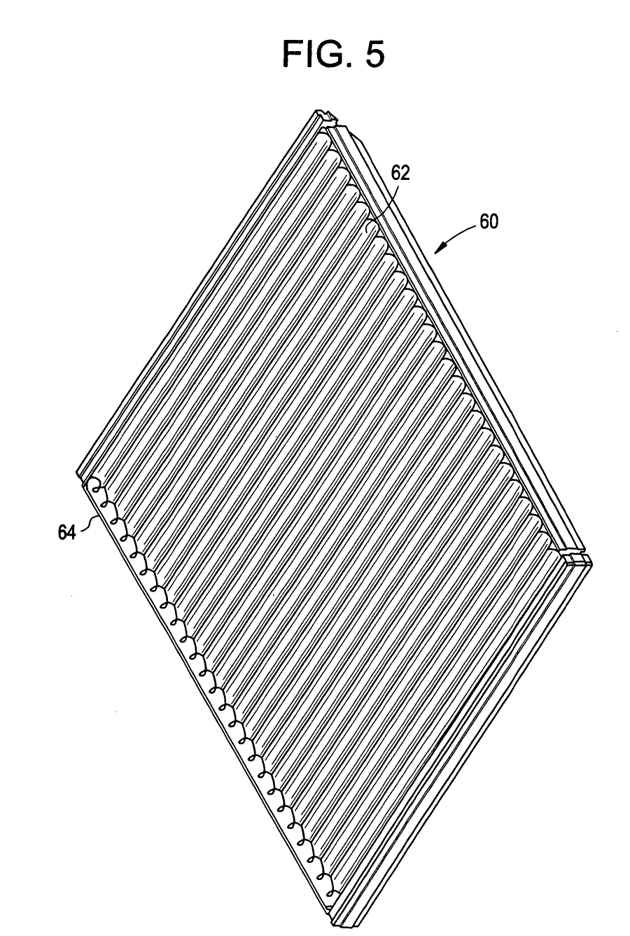

FIG. 5 is another view showing the scalloped profile on the front of the light box.

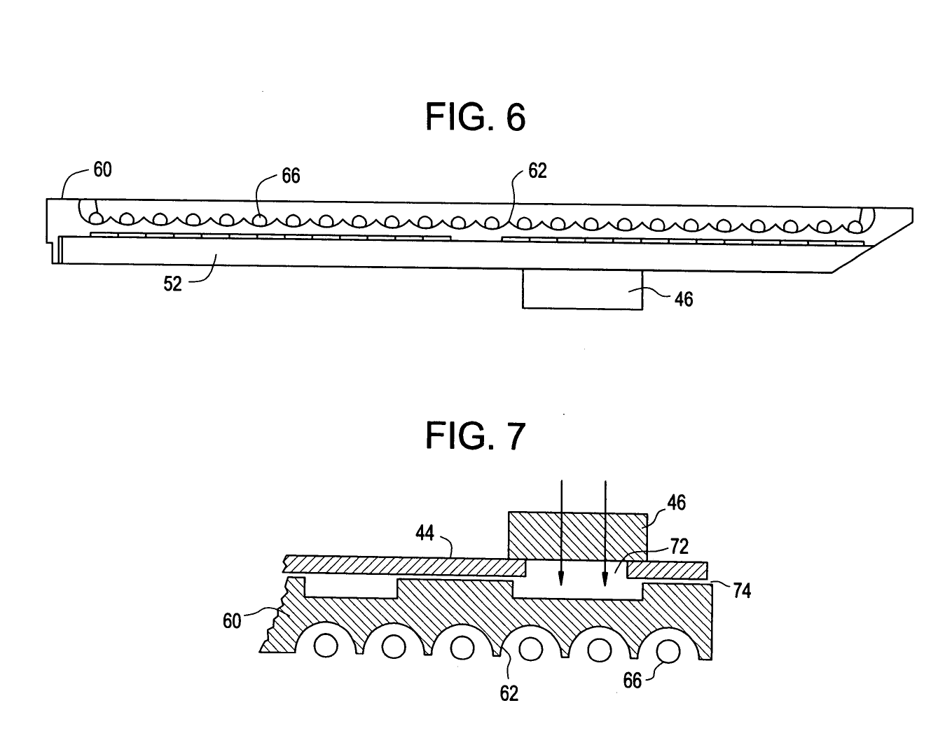

FIG. 6 is a cross-section showing the relationship of the light box 60, the fluorescent bulbs 66, the main circuit board 44 and the cooling fans 46. As can be seen, the circuit board fits into the back of the light box and is fixedly secured by screws or any other convenient fastening method. Each of the fluorescent bulbs 66 are mounted in the front of the light box 60 in a scalloped recess 62 and the wires 68 pass through the light box for connection to the printed circuit board 44. Each of the cooling fans 46 is mounted to the rear of the main circuit board 44 by screws 84 or other convenient means so that it will discharge through cooling pan output passages 82 in the circuit board 44 to enter into the cooling troughs 74 or plenum 72 formed by the coaction of the main circuit board 44 and the back of the light box 60.

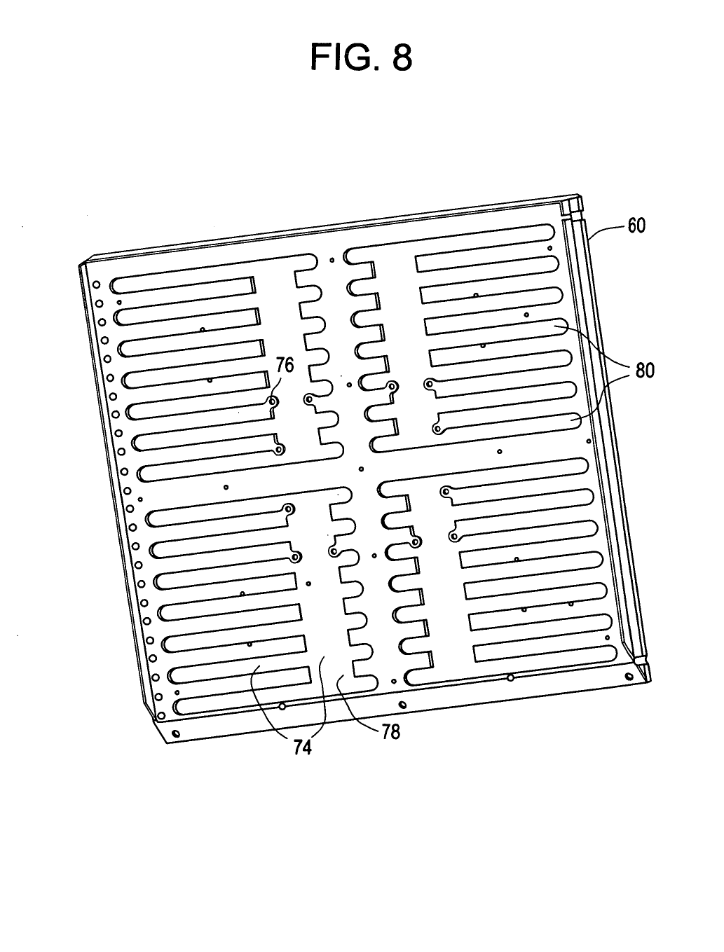

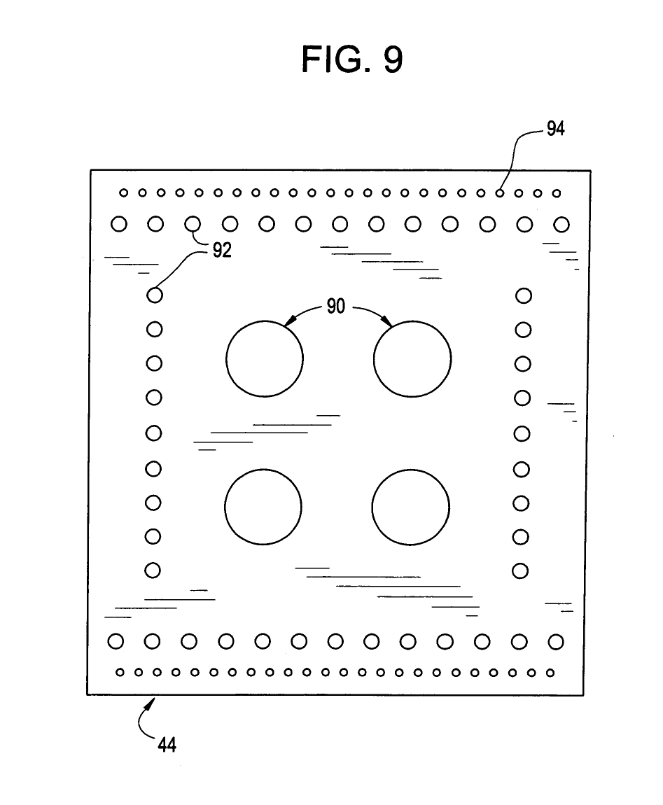

In FIG. 7, we see the relationship between the light box, the circuit board 44, the fan 46 and the fluorescent tubes 66. Each fluorescent tube 66 lies within its particular receptacle 62. The light box 60 is intricately machined as shown in FIG. 8 to form a series of cooling passages 80 and which join into cooling manifolds 78 which in turn are positioned with relation to one of the cooling fans 46 mounted on the back of the main circuit board. The rear of the light box is machined with numerous cooling troughs. The cooling troughs form cooling passages which connect to cooling manifolds in coaction with the front side of the main circuit board 44. The circuit board presses against the raised portions of the light box direction the airflow through the cooling passages of plenums. The cooling manifolds communicate with the openings forming the cooling fan output passages 90A,B,C and D in the main circuit board 44. Fans 46A,B,C and D are mounted on top of these openings and discharge air down into the cooling manifolds 78 which distribute the air to the cooling passages 80. This tends to keep the rear of the light box at a uniform, even temperature and avoid hot spots.

Additionally, thermostatic controls mounted on the rear of the main circuit board can control the operation of the cooling fans to level or make uniform the operating temperature at the rear of the light box, and therefore, by heat transfer at the location of the fluorescent tubes in the front of the light box.

Note that there are screw holes 76 located in each of the cooling manifolds for the mounting of the cooling fans. The screw holes align and are in registration with screw holes in the main circuit board so that the fans themselves are anchored down to the light box.

Since the main circuit board 44 fits snugly within the rear of the light box 60, the air which has been forced by the fan 46 into the cooling manifold 78 and cooling passages 80 will travel until it is discharged through the inverter cooling passages 92 running horizontally and vertically on the circuit board so that the cooling air that is discharged from the cooling manifold will cool the inverters and the circuits that are mounted on the main circuit board 44. Note that the main circuit board also has a passage 94 formed in it for the wires that come from the fluorescent tubes so there will be a line of holes for the fluorescent tube wires on each side of the board.

As can be seen from the above description, the high intensity back light assembly of the present invention provides an efficient, effective, and durable apparatus of relatively simplified construction. The coaction between the rear of the light box and the main circuit board to provide cooling means for the apparatus insures extended service life for the components and optimum performance.

It will be understood that the embodiments described herein are merely exemplary and that a person skilled in the art may make many variations and modifications without departing from the spirit and scope of the invention. All such modification and variations are intended to be included within the scope of the invention as described herein.

I claim:

1. A high density back light assembly comprising;
a display;
a first circuit board;
a light box disposed between the display and the first circuit board;
a plurality of light sources positioned between the light box and the display;
the first circuit board contacting and overlaying the light box;
an array of cooling troughs formed in the side of the light box proximate the first circuit board;
the first circuit board and the array of cooling troughs on said light box coacting to form cooling passages between the first circuit board and the light box;
at least one fan discharge passage formed in the first circuit board;
a fan mounted on the circuit board in registration with each discharge passage; and
the fan operative to discharge air through the discharge passage into the cooling passages to cool the light box.

2. A high intensity back light assembly of claim 1 further comprising;
Exhaust passages in said circuit board communicating with the cooling passages to permit flow of air from the fan through the cooling passages and out the exhaust passage.

3. A high intensity back light assembly of claim 2 further comprising;
at least one secondary circuit board mounted on the circuit board the secondary circuit board positioned on the circuit board in relation to the exhaust passages to receive the airflow from the exhaust passages to cool the secondary circuit board.

4. A high intensity back light assembly of claim 1 further comprising;
each of the plurality of light sources positioned between the light box and the display comprising;
a flourescent light bulb;
electrical connecting wires extending from the flourescent light bulb;
passages in the light box for the electrical connecting wires; and
the electrical connecting wires passing through the passages in the light box and connected to the circuit board.

5. A high intensity back light assembly of claim 4 further comprising;
an insulating spacer positioned on each of the electrical connecting wires between the flourescent bulb and the light box to position the flourescent bulb with respect to the light box;

6. A high intensity back light assembly of claim 1 further comprising;
the surface of the light box proximate the display having a scalloped surface forming a plurality of depressions each of the depressions adapted to receive a light source and reflect light towards the display.

7. A high density back light assembly of claim 6 further comprising;
each of the plurality of light sources positioned between the light box and the display comprising;
a flourescent light bulb;
electrical connecting wires extending from the flourescent light bulb;
passages in the light box for the electrical connecting wires;
the electrical connecting wires passing through the passages in the light box and connected to the first circuit board.

8. A high intensity back light assembly of claim 1 comprising;
at least one of the fans being fastened to the light box through the first circuit board.

9. A high intensity back light assembly of claim 4 comprising;
connecting passages on the first circuit board for connecting each of the electrical connecting wires from the light sources to the circuit board.

10. A high intensity back light assembly comprising;
a display;
a first circuit board;
a light box disposed between the display and the first circuit board;
a plurality of light sources positioned between the light box and the display;
the first circuit board contacting and overlaying the light box;
an array of cooling troughs formed in the side of the light box proximate the first circuit board;
the first circuit board and the array of cooling troughs on said light box coacting to form cooling passages between the first circuit board and the light box;
at least one fan discharge passage formed in the first circuit board;
a fan mounted on the first circuit board in registration with each discharge passage;
the fan operative to discharge air through the discharge passage into the cooling passages to cool the light box;
the exhaust passages in said first circuit board communicating with the cooling passages to permit flow of air from the fan through the cooling passages and out the exhaust passage;
at least one secondary circuit board mounted on the first circuit board the second circuit board position on he first circuit board n relation to the exhaust passages to receive airflow from the exhaust passages to cool the secondary circuit board;
each of the plurality of light sources positioned between the light box and display comprising;
a flourescent light bulb;
electrical connecting wires extending from the flourescent light bulb;
passages in the light box for the electrical connecting wires;
the electrical connecting wires passing through the passages in the light box and connected to the circuit board;
an insulating spacer positioned on each of the electrical connecting wires between the flourescent bulb and the light box to position the flourescent bulb with respect to the light box;
the surface of the light box proximate the display having a scalloped surface formed a plurality of depressions adapted to receive a light source and reflect light towards the display;
at least one of the fans being fastened to the light box through the circuit board; and
connecting passages on the circuit board for connecting each of the electrical connecting wires from the light sources to the circuit board.
